(19) United States
(12) Patent Application Publication
(10) Pub. No.: US 2015/0183691 A1
(43) Pub. Date: Jul. 2, 2015

(54) MANUFACTURING METHOD AND REPAIRING METHOD

(71) Applicants: Steffen Walter, Oberpframmern (DE); Marco Cologna, Munchen (DE); Stefan Lampenscherf, Poing (DE); Anand A. Kulkarni, Charlotte, NC (US); Cora Schillig, Orlando, FL (US); Gia Khanh Pham, Charlotte, NC (US)

(72) Inventors: Steffen Walter, Oberpframmern (DE); Marco Cologna, Munchen (DE); Stefan Lampenscherf, Poing (DE); Anand A. Kulkarni, Charlotte, NC (US); Cora Schillig, Orlando, FL (US); Gia Khanh Pham, Charlotte, NC (US)

(21) Appl. No.: 14/146,243

(22) Filed: Jan. 2, 2014

(51) Int. Cl. C04B 35/64; C04B 35/488

(52) U.S. Cl. CPC C04B 35/64; C04B 35/488

(57) ABSTRACT

A manufacturing method for manufacturing a slice for making or repairing a heat protective coating of a hot gas path component of a gas turbine is provided. The manufacturing method includes debinding a prepreg made of at least two sheets containing powder bound by a binder and Spark Plasma Sintering the at least two debound sheets.

### FIELD OF TECHNOLOGY

The invention relates to a method for manufacturing a slice for making or repairing a heat protective coating of a hot gas path component of a gas turbine.

### TECHNICAL BACKGROUND

High temperature nickel-based alloys are commonly used for the manufacture of a wide range of hot gas path components, for example discs, casings, vane segments and turbine blades. Some of them, particularly the highly alloyed materials with a high content of aluminium (Al) and titanium (Ti) are very difficult to weld. The high content of aluminium and titanium will cause a precipitation of hardened Gamma-prime phase and an increased crack susceptibility of the parts during the welding process.

In the prior art the Spark Plasma Sintering (SPS) process is known. Spark Plasma Sintering is a sintering process that is also known as Field Assisted Sintering Technique (FAST) or Pulsed Electric Current Sintering (PECS). In Spark Plasma Sintering a pulsed or continuous current is led through compacted metal powder contained within a mould. The heat produced by the current causes sintering of the metal powder achieving densification close to theoretical maximum density but at lower sintering temperatures compared to conventional sintering processes.

In view of the aforegoing it is an object of the invention to provide a new method for joining difficult weldable nickel-based super alloys for gas turbine applications.

### SUMMARY OF THE INVENTION

In order to solve the abovementioned object, the invention provides a method for manufacturing a slice for making or repairing a heat protective coating of a hot gas path component of a gas turbine. The manufacturing method comprises debinding a prepreg made of at least two sheets containing powder bound by a binder and Spark Plasma Sintering the at least two debound sheets.

Using the Spark Plasma Sintering technology difficult to weld nickel-based super alloys can be bonded together. Moreover, the Spark Plasma Sintering technology can also be utilized for the bonding of other kinds of super alloys, for example iron-, cobalt-based, and refractory alloys, for example tantalum, hathium, tungsten, molybdenum, niobium, as well as combination of them.

The new technical feature of the invention is to combine the Spark Plasma Sintering technology with the multilayer technology. By this measure it is possible to bond different types of materials and manufactured tailored material compositions in order to the technical requirements.

In a further embodiment of the inventive method the manufacturing method comprises laminating the least two sheets to the prepreg.

Thus, the manufacturing method also includes the preparation of the prepreg.

In a still further embodiment of the inventive method the manufacturing method comprises producing at least one of the sheets by cutting out or punching out the sheet from a tape containing powder bound by a binder.

Thus, the manufacturing method also includes the preparation of the sheets.

In a still further embodiment of the inventive method the manufacturing method comprises producing the tape in a tape casting process out of slurry containing at least powder and binder and solvent. The slurry may contain 70 mass % powder and 15 mass % organic binder and 13 mass % solvent and 2 mass % additives.

By this composition of the slurry a tape can be produced which is particularly suitable for the production of the sheets.

The inventive manufacturing method may comprise setting a process temperature of 1000° C. to 1200° C. for the Spark Plasma Sintering. The Spark Plasma Sintering may comprise setting a heating rate and cooling rate of 50 K/min to 200 K/min. Particularly the Spark Plasma Sintering may comprise setting a bonding time of 30 min to 60 min.

This process conditions have been proven for a good Spark Plasma Sintering result with a high bonding quality and a homogenous microstructure. The process time is short and the process energy and also the carbon dioxide emission are low. A grain growth is suppressed and a mechanical strength is increased. Thus, a positive impact of the life-time is generated.

In a preferred embodiment of the inventive manufacturing method at least one sheet which contains braze metal powder is used.

By this measure the slice can be provided with a bond coat.

In a preferred embodiment of the inventive manufacturing method at least one of the sheets contains Ytterbium Zirconate powder.

By this measure the slice can be provided with a thermal barrier coat.

In a preferred embodiment of the inventive manufacturing method at least one of the sheets contains Yttria-stabilized Zirconia powder.

By this measure the slice can be provided with a supplementary thermal barrier coat.

In a preferred embodiment of the inventive manufacturing method at least one of the sheets contains MCrAlY powder.

By this measure the slice can be provided with a bond coat for joining a ceramic layer with a metal layer.

In a further embodiment of the inventive manufacturing method at least one of the sheets contains a blend of MCrAlY powder and Yttria-stabilized Zirconia powder.

By this measure the slice can be provided with a gradient layer.

In a still further embodiment of the inventive manufacturing method some of the sheets contain the same powder.

By this measure the slice can be provided with layers with different thicknesses.

Further features, properties and advantages of the present invention will become clear from the following description of embodiments in conjunction with the accompanying drawings. In the drawings:

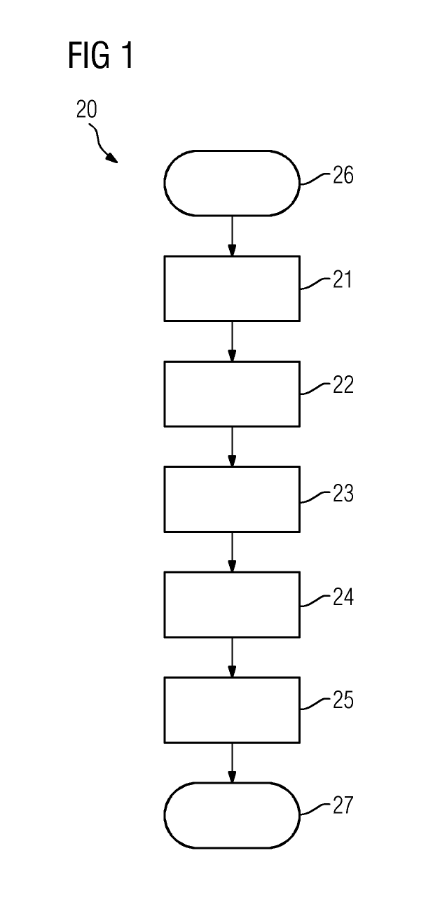

FIG. 1 shows a manufacturing method according to the invention;

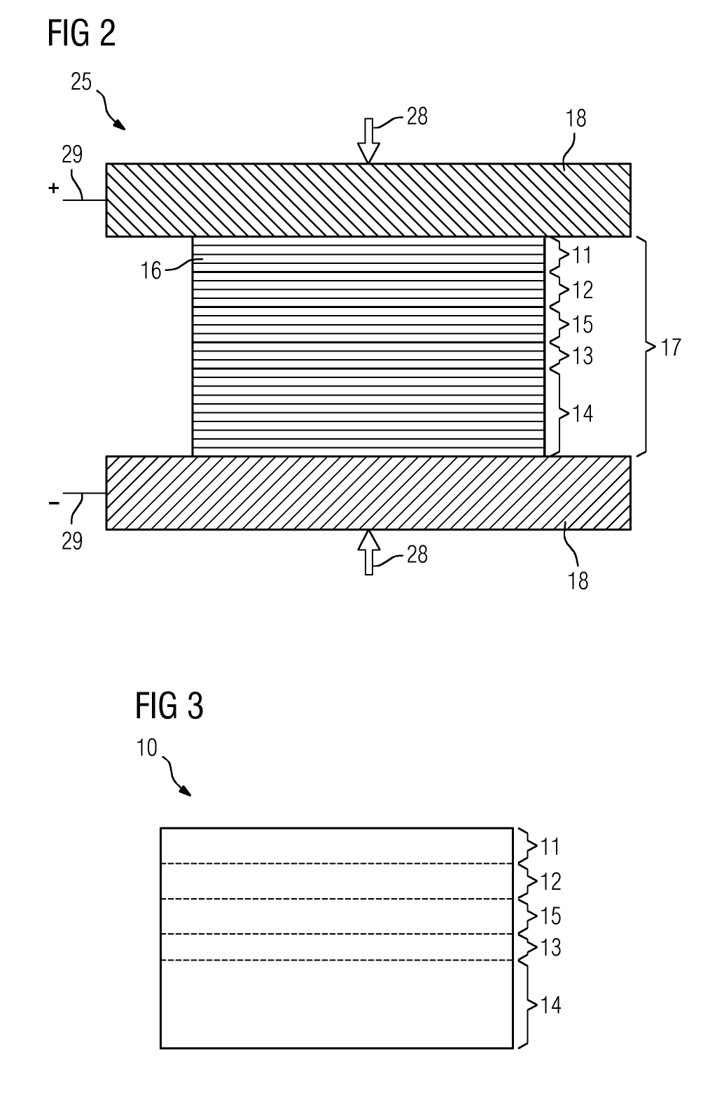

FIG. 2 illustrates a step of the manufacturing method; and

FIG. 3 shows a slice manufactured by the method of the invention.

The present invention will now be described, by way of example, with reference to the accompanying drawings.

In FIG. 1 an illustrative example of the inventive manufacturing method 20 is shown in a flow diagram beginning at a start 26 and ending at an end 27. The embodiment of the manufacturing method 20 shown in FIG. 1 comprises five process steps.

In a first step a thin tape is produced 21. Particularly, the tape may be produced applying a tape casting technology. The tape may be formed from slurry containing powder, organic binder, solvent and additives. The powder may be a metal powder or a ceramic powder or a blend of a metal powder and a ceramic powder. For example, the slurry may comprise 70 mass % powder, 15 mass % organic binder, 13 mass % solvent and 2 mass % additives. The tape casting process is well-known in the art. The tape producing process 21 provides a thin film which comprises powder bound by the hardened binder. The organic binder may be a polyethylene terephthalate (PET). The tape may comprise a thickness between 40 μm an 200 μm. The tape is flexible and may comprise 80 vol % to 90 vol % powder and between 10 vol % and 20 vol % binder system including binder, solvent and additives.

In a second step a sheet 16 is produced 22. Particularly, the sheet 16 may be cut out or punched out from the tape. It is also conceivable that at least two prefabricated sheets 16 are used in the following steps.

In a subsequent third step at least two sheets 16 are laminated 23 together to a prepreg 17. In order to achieve this, the at least two sheets are stacked and subsequently heated moderately in such a manner as to melt the binder of the sheets 16 at the surface of the sheets 16. Then the sheets 16 are left to cool again. In this way, the binders of the two sheets are joined.

In a fourth step the prepreg 17 is debound 24. During the debinding process the binder is melted out of the prepreg 17. A suitable debinding temperature may be between 400° C. and 800° C.

In a fifth step the prepreg 17 is sintered by a Spark Plasma Sintering method 25.

FIG. 2 illustrate the Spark Plasma Sintering 25. In the example the powders of the twenty-five sheets 16 of the prepreg 17 are joined firmly by Spark Plasma Sintering 25. The twenty-fife sheets 16 form five layers 11, 12, 13, 14, 15. Every layer 11, 12, 13, 14, 15 comprises a plurality of sheets 16. Every sheet 16 of one of the layers may comprise the same powder, respectively.

For example, a first layer 11 may contain four sheets 16 including Ytterbium Zirconate (YBZO) powder, in particular Yb2Zr2O7. A second layer 12 arranged underneath the first layer 11 may contain four sheets 16 including Yttria-stabilized Zirconia (YSZ) powder, in particular 8YSZ. An interlayer 15 arranged underneath the second layer 12 may contain four sheets 16 including MCrAlY powder and Yttria-stabilized Zirconia (YSZ) powder. A third layer 13 arranged underneath the interlayer 15 may contain three sheets 16 including MCrAlY powder. And a fourth layer 14 arranged underneath the third layer 13 may contain ten sheets 16 including braze metal powder, in particular CM247,

The sheets 16 are arranged in a Spark Plasma Sintering device 18. For joining the sheets 16 a temperature of 1000° C. to 1200° C. is generated by a current flowing through the sheets 16 in response to a voltage 29. In the shown example a positive voltage is applied at the first layer 11 containing Ytterbium Zirconate (YBZO) powder and a negative voltage is applied at the fourth layer 14 containing braze metal powder. In order to join a ceramic layer as the second layer 12 and a metal layer as the third layer 13, the positive voltage should be applied at the ceramic side and the negative voltage should be applied at the metal side. The voltage may be applied in pulses or continuously. The heating is carried out in such a manner that a heating rate is between 50 K/min and 200 K/min.

While heating, a pressure 28 is applied to the sheets 16. The pressure 28 may be applied by the Spark Plasma Sintering device 18. The pressure may be between 1 MPa and 40 Mpa.

After a bonding time of 30 min to 60 min the process temperature may be reduce with a cooling rate of 50 K/min to 200 K/min.

The total Spark Plasma Sintering process 20 including heating bonding and cooling may take between 2 hours and 3 hours.

FIG. 3 shows a slice 10 as produced by the Spark Plasma Sintering 25 process illustrated by FIG. 2. In the slice 10 the formerly powder particle of the twenty-fife sheets 16 are joined together firmly to a monolith. The slice 10 may comprise five layers in accordance with the five layers of the prepreg 17 shown in FIG. 2. The first layer 11 is made of Ytterbium Zirconate (YBZO) and may form a thermal barrier coat. The second layer 12 arranged underneath the first layer 11 is made of Yttria-stabilized Zirconia (YSZ) and may form a supplementary thermal barrier coat. The interlayer 15 arranged underneath the second layer 12 is made of a blend of MCrAlY and Yttria-stabilized Zirconia (YSZ) and may form a gradient coat. The ratio of Yttria-stabilized Zirconia (YSZ) and MCrAlY in the interlayer 15 may be between 50:50 and 30:70. The third layer 13 arranged underneath the interlayer 15 is made of MCrAlY and may form a bond coat. And the fourth layer 14 arranged underneath the third layer 13 is made of braze metal and may form a substrate coat.

The slice 10 has a preferred diameter of 20 mm to 80 mm. The slice 10 may be usable for making or repairing a heat protective coating of a hot gas path component of a gas turbine. In a repairing method the slice 10 may be applied at a damaged area of an existing heat protective coating.

While the invention has been described by referring to preferred embodiments and illustrations thereof, it is to be understood that the invention is not limited to the specific form of the embodiments shown and described herein, and that many changes and modifications may be made thereto within the scope of the appended claims by one of ordinary skill in the art.

We claim:

1. A manufacturing method for manufacturing a slice for making or repairing a heat protective coating of a hot gas path component of a gas turbine, comprising:
debinding a prepreg made of at least two sheets containing powder bound by a binder; and
Spark Plasma Sintering the at least two debound sheets.

2. The manufacturing method as claimed in claim 1, further comprising laminating the least two sheets to the prepreg.

3. The manufacturing method as claimed in claim 2, further comprising producing at least one of the sheets by cutting out or punching out the sheet from a tape containing powder bound by a binder.

4. The manufacturing method as claimed in claim 3, further comprising producing the tape in a tape casting process out of slurry containing at least powder and binder and solvent.

5. The manufacturing method as claimed in claim 4, wherein the slurry contains 70 mass % powder and 15 mass % organic binder and 13 mass % solvent and 2 mass % additives.

6. The manufacturing method as claimed in claim 1, wherein Spark Plasma Sintering comprises setting a process temperature of 1000° C. to 1200° C.

7. The manufacturing method as claimed in claim 1, wherein Spark Plasma Sintering comprises setting a heating rate and cooling rate of 50 K/min to 200 K/min.

8. The manufacturing method as claimed in claim 1, wherein Spark Plasma Sintering comprises setting a bonding time of 30 min to 60 min.

9. The manufacturing method as claimed in claim 1, wherein at least one of the sheets contains braze metal powder.

10. The manufacturing method as claimed in claim 1, wherein at least one of the sheets contains Ytterbium Zirconate powder.

11. The manufacturing method as claimed in claim 1, wherein at least one of the sheets contains Yttria-stabilized Zirconia powder.

12. The manufacturing method as claimed in claim 1, wherein at least one of the sheets contains MCrAlY powder.

13. The manufacturing method as claimed in claim 1, wherein at least one of the sheets contains a blend of MCrAlY powder and Yttria-stabilized Zirconia powder.

14. The manufacturing method as claimed in claim 1, wherein some of the sheets contain the same powder.
